(19) United States
(12) Patent Application Publication
(10) Pub. No.: US 2022/0171955 A1
(43) Pub. Date: Jun. 2, 2022

(54) SYMBOL BORDER IDENTIFICATION DEVICE, SYMBOL BORDER IDENTIFICATION METHOD, AND NON-TRANSITORY COMPUTER READABLE MEDIUM

(71) Applicant: OMRON Corporation, KYOTO (JP)

(72) Inventor: Masahiro FUJIKAWA, Kyoto-shi, Kyoto (JP)

(73) Assignee: OMRON Corporation, KYOTO (JP)

(21) Appl. No.: 17/432,946

(22) PCT Filed: Jan. 30, 2020
(86) PCT No.: PCT/JP2020/003334

§ 371 Date: Aug. 23, 2021

(30) Foreign Application Priority Data
Mar. 1, 2019 (JP) 2019-038024

(51) Int. Cl. G06K 7/14; G06V 10/22; G06V 10/25

(52) U.S. Cl. CPC G06K 7/1452; G06V 10/25; G06V 10/225; G06K 7/1443

(57) ABSTRACT

The present invention makes the identification of a border of a symbol less susceptible to the influence of disturbing noise, and reduces processing time. A symbol border identification device (5) which: identifies a reference position of an element constituting a symbol from decoding results of the symbol; determines whether a region is within the symbol on the basis of profile information that relates to the region and that is based on the reference position; and identifies a border of the symbol on the basis of a border element candidate identified in accordance with the determination result.

### BACKGROUND OF THE INVENTION

### Field of the Invention

The invention relates to a symbol border identification device identifying a border of a symbol included in an image.

### Description of Related Art

For the purpose of object identification, management, etc., symbols having information, such as one-dimensional symbols, two-dimensional symbols, etc., are used.

As a technique of using symbols, for example, a two-dimensional code reading device is disclosed in Patent Document 1. Specifically, the reading device includes a two-dimensional code outline presence region determination part which detects a guide cell vertex to determine a two-dimensional code outline presence region. In addition, the reading device is configured as including a guide cell circumscribing line detecting part detecting a guide cell circumscribing line, a timing cell circumscribing line detecting part detecting a timing cell circumscribing line, a timing cell detecting part detecting a timing cell, etc. The guide cell and the timing cell form the outer edge of the two-dimensional code.

### PRIOR ART DOCUMENT

### Patent Document

[Patent Document 1] Japanese Laid-open No. 2002-329163 (published on Nov. 15, 2002).

### SUMMARY OF THE INVENTION

### Problems to be Solved by the Invention

However, in the conventional technology, the identification of a symbol border is susceptible to the influence of disturbing noise. The disturbing noise includes, for example, dirt of a quiet zone provided on the outer side of the symbol, uneven printing, and noise on the edge of the symbol caused by printing on the casting surface, etc.

In the symbols containing information as described above, some symbols include a text string adjacent to the symbol. In the symbol reading device, etc., a region in which a text string is present is set as a text recognition region. Then, a text string recognition process is performed in the text recognition region by using the symbol reading device, etc. In such symbol reading device, when the border of the symbol is not properly identified, the text recognition region cannot be properly set. The reasons why the text recognition region cannot be set properly may include failure in recognizing the text, delayed text recognition processing time, etc.

An objective of an aspect of the invention is to make the identification of the border of a symbol less susceptible to the influence of disturbing noise and realize a symbol reading device capable of reducing processing time.

### Means for Solving Problems

In order to solve the above issues, a symbol border identification device according to an aspect of the invention includes: a decode part, identifying reference positions of a plurality of elements forming a symbol by decoding the symbol included in an image; a profile information identification part, obtaining profile information with respect to a plurality of regions set based on the reference positions; a determination part, determining whether the regions are in the symbol based on the profile information; a border element identification part, identifying at least one border element candidate by using position information of the regions determined as in the symbol; and a border identification part, identifying at least one border of the symbol based on the border element candidate.

In addition, a symbol border identification method according to an aspect of the invention includes: a decode step, identifying reference positions of a plurality of elements forming a symbol by decoding the symbol comprised in an image; a profile information identification step, obtaining profile information with respect to a plurality of regions set based on the reference positions; a determining step, determining whether the regions are in the symbol based on the profile information; a border element identification step, identifying at least one border element candidate by using position information of the regions determined as in the symbol; and a border identification step, identifying at least one border of the symbol based on the border element candidate.

### [Inventive Effects]

According to an aspect of the invention, the identification of the border of a symbol can be less susceptible to the influence of disturbing noise, and the processing time for identifying the border of the symbol can be reduced.

### BRIEF DESCRIPTION OF THE DRAWINGS

FIG. 1 is a block diagram illustrating an example of the configuration of components of a symbol reading device according to an embodiment of the invention.

FIG. 2 is a diagram illustrating an example of a symbol whose border is identified by the symbol border identification device according to an embodiment of the invention.

(a) to (c) of FIG. 3 are diagrams illustrating examples of types of symbols whose borders are identified by the symbol border identification device according to an embodiment of the invention.

(a) to (d) of FIG. 4 are diagrams illustrating other examples of types of symbols whose borders are identified by the symbol border identification device according to an embodiment of the invention.

FIG. 5 is a flowchart illustrating an example of a flow of processes executed by the symbol border identification device according to an embodiment of the invention.

FIG. 6 is a schematic diagram illustrating a method with which a profile information identification part sets the direction of a scanning line according to an embodiment of the invention.

(a) to (d) of FIG. 7 are diagrams illustrating an example of the method with which the profile information identification part sets a module arrangement direction according to an embodiment of the invention.

(a) to (d) of FIG. 8 are diagrams illustrating an example of identifying a border point candidate according to an embodiment of the invention.

(a) to (d) of FIG. 9 are schematic diagrams illustrating a flow of a process for individually identifying multiple border points according to an embodiment of the invention.

(a) to (c) of FIG. 10 are diagrams illustrating another example of identifying a border point candidate according to an embodiment of the invention.

(a) to (c) of FIG. 11 are diagrams illustrating another example of identifying a border point candidate according to an embodiment of the invention.

(a) to (c) of FIG. 12 are schematic diagrams illustrating an example of a flow of a process for simultaneously identifying multiple border points according to an embodiment of the invention.

(a) to (e) of FIG. 13 are schematic diagrams illustrating an example of a flow of a process for identifying one border point candidate from multiple verification points according to an embodiment of the invention.

(a) to (c) of FIG. 14 are schematic diagrams illustrating an example of a flow of a process for identifying a border point candidate by using a width of an element in a scan line direction according to an embodiment of the invention.

(a) and (b) of FIG. 15 are schematic diagrams illustrating an example of a flow of a process for identifying one border point candidate by using widths of multiple elements in the scan line direction according to an embodiment of the invention.

(a) to (c) of FIG. 16 are schematic diagrams illustrating an example of a flow of a process for identifying one border point candidate by using an element width ratio according to an embodiment of the invention.

FIG. 17 is a schematic diagram illustrating identifying one border point candidate by using an element width ratio according to an embodiment of the invention.

(a) and (b) of FIG. 18 are schematic diagrams illustrating an example of a flow of a process for identifying one border point candidate by using a ratio of a width of a set of multiple elements with respect to a predetermined width p according to an embodiment of the invention.

FIG. 19 is a diagram illustrating a modified example of a two-dimensional symbol whose border is identified by a symbol border identification device according to a modified example of the invention.

### DESCRIPTION OF THE EMBODIMENTS

Hereinafter, the embodiments according to an aspect of the invention (hereinafter, also referred to as “the embodiment”) will be described with reference to the drawings.

### 1. Application Example

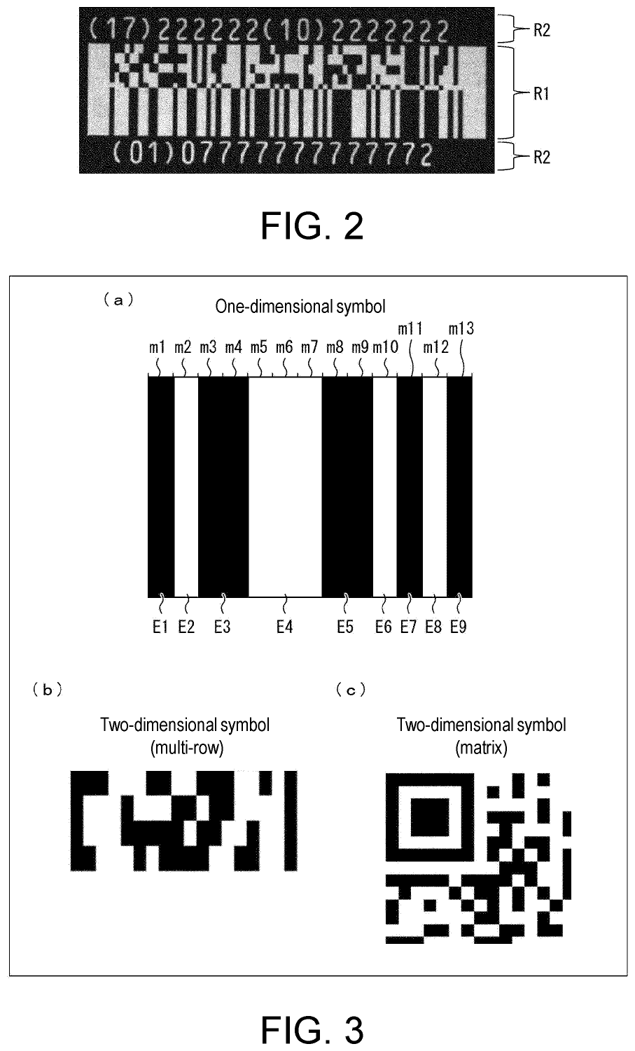

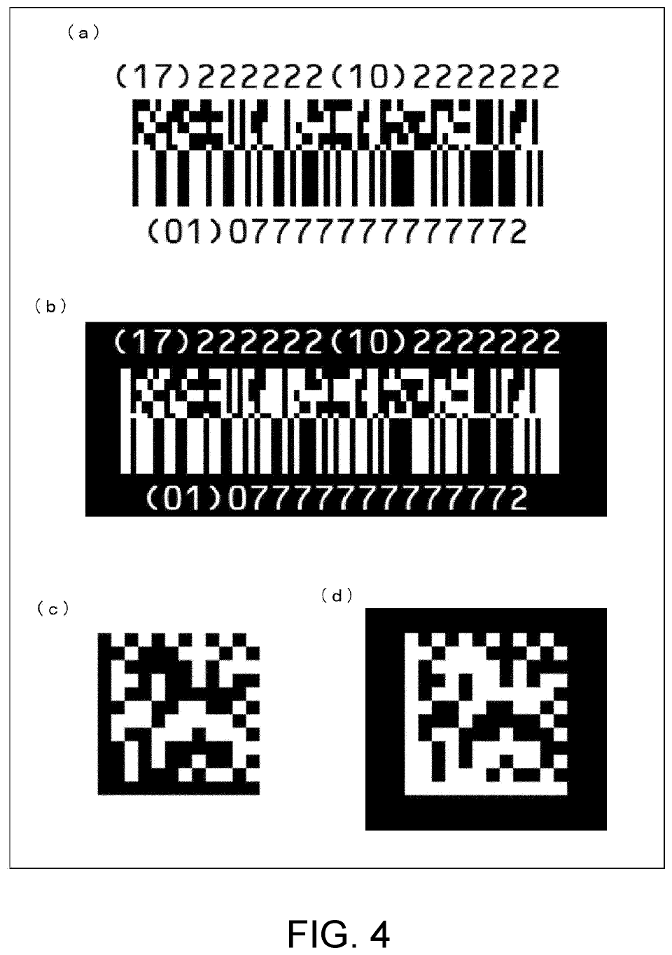

FIG. 2 is a diagram illustrating an example of a symbol whose border is identified by a symbol border identification device 5 according to the embodiment. Firstly, an application example of the symbol border identification device 5 will be briefly described by using FIG. 2. The symbol shown in FIG. 2 is an example of a two-dimensional symbol. As shown in FIG. 2, the symbol is provided in a region R1 in the symbol border. In addition, text recognition regions R2 are provided to be adjacent to the region R1 within the border of the symbol. In the text recognition region R2, a test string is provided. For example, a symbol reading device 1 identifies the text recognition regions R2 from symbol borders, and performs a process for recognizing the text strings provided in the text recognition regions R2.

The symbol border identification device 5 is hardly susceptible to the influence of disturbing noise and identifies the border of the symbol in a short processing time. As described above, the disturbing noise includes, for example, dirt of a quiet zone provided on the outer side of the symbol, uneven printing, and noise at the edge of the symbol caused by printing on the casting surface, etc.

FIG. 3 illustrate examples of types of symbols whose borders are identified by the symbol border identification device 5. (a) of FIG. 3 illustrates an example of a one-dimensional symbol (e.g., code 39, code 128). (b) of FIG. 3 illustrates an example of a multi-row type two-dimensional symbol (e.g., microPDF417). (c) of FIG. 3 illustrates an example of a matrix type two-dimensional symbol (e.g., QR code (registered trademark)).

Here, (a) of FIG. 3 is used to described an example of a symbol configuration. The symbol is formed by multiple modules as minimum units. In the example shown in (a) of FIG. 3, the symbol is formed by modules m1 to m13. In addition, each module is either colored in a symbol color or a background color. In the example shown in (a) of FIG. 3, the modules m1, m3, m4, m8, m9, m11, and m13 are provided with a black symbol color. Meanwhile, the modules m2, m5, m6, m7, m10, and m12 are provided with a white background color.

Adjacent modules of the same color, for example, form an element which is a bar or a space, for example. In the example shown in (a) of FIG. 3, the modules m3 and m4 form one element (bar) E3. In addition, the modules m5, m6, and m7 form one element (space) m4. As shown in E1, E2, etc., in (a) of FIG. 3, in the case where the adjacent modules are not in the same color, each individual module forms one element.

(a) to (d) of FIG. 4 are diagrams illustrating other examples of types of symbols whose borders are identified by the symbol border identification device 5. (a) of FIG. 4 illustrates an example of a symbol in the case where the symbol color provided to the modules is black, the background color provided to the modules is white, and the periphery color of the periphery of the symbol is white. (b) of FIG. 4 illustrates an example of a symbol in the case where the symbol color provided to modules is black, the background color provided to the modules is white, and the periphery color of the periphery of the symbol is black. (c) of FIG. 4 illustrates an example of a symbol in the case where the symbol color provided to modules is black, the background color provided to modules is white, and the periphery color of the periphery of the symbol is white. (d) of FIG. 4 illustrates an example of a symbol in the case where the symbol color provided to modules is white, the background color provided to modules is black, and the periphery color of the periphery of the symbol is black. In the following descriptions, for the ease of description, a symbol in the case where the symbol color is black, the background color is white, and the periphery color of the periphery of the symbol is white is described. However, the pattern of the colors of the modules forming a symbol is not limited thereto.

The symbol border identification device 5 identifies reference positions of multiple elements forming the symbol by decoding the symbol included in an image. For example, the reference positions may be the centers of the modules forming the respective elements calculated from the edge points of the respective elements in the scan line used in a decoding process for the symbol.

In addition, the symbol border identification device 5 obtains profile information with respect to multiple regions set based on the reference positions and determines whether the regions are in the symbol. For example, the symbol border identification device 5 may scan within the element by sequentially setting the region and obtaining the profile information set from the center of the element toward the outside of the element.

The profile information may be a pixel value, a pixel value variation, binary data, and a width of the element, a normalized value of the width of the element (a ratio of the width of the element with respect to a predetermined width), etc.

The symbol border identification device 5 identifies at least one border element candidate by using the position information of the region determined as in the symbol, and identifies at least one border of the symbol based on the border element candidate.

According to the configuration, among the regions based on the reference position of the multiple elements identified by decoding the symbol, by using the position information of the region determined as in the symbol, at least one border of the symbol is identified.

That is, since the position information of the region determined as in the symbol is used, the identification of the border of the symbol can be less susceptible to the influence due to disturbing noise outside the symbol.

In addition, according to the above configuration, by decoding the symbol included in the image, the reference positions of the multiple elements forming the symbol are identified. That is, the border of the symbol can be identified by using the information obtained by the decoding process. Therefore, the processing time for identifying the symbol border can be reduced.

### 2. Configuration Example

### (Symbol Reading Device 1)

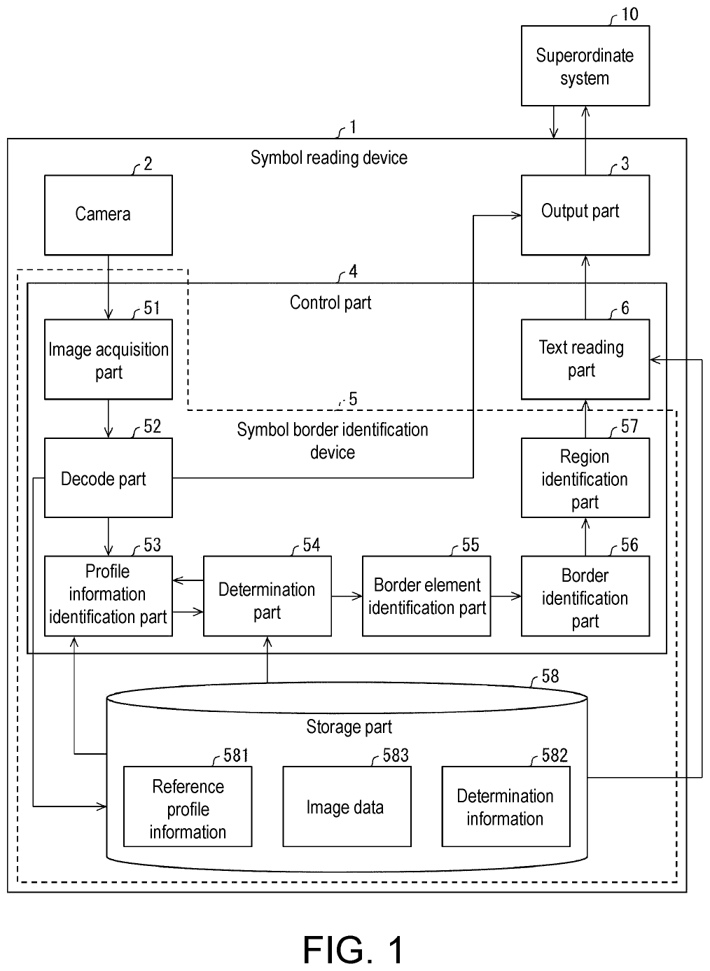

FIG. 1 is a block diagram illustrating an example of the configuration of components of the symbol border identification device 5 according to an embodiment of the invention. In the embodiment, an example in which the symbol border identification device 5 is integrated with the symbol reading device 1 is shown. However, the symbol border identification device 5 may be separated from the symbol reading device 1.

The symbol reading device 1 shown in FIG. 1 includes a camera 2, an output part 3, a control part 4, and a storage part 58. In addition, the symbol border identification device 5 is formed by the configuration of a portion of the control part 4 and the storage part 58.

(Camera 2)

The camera 2 photographs the symbol. The camera 2 outputs photographed image data to an image acquisition part 51.

(Control Part 4)

The control part 4 includes a central processing unit (CPU), a random access memory (RAM), a read only memory (ROM), etc., and performs control on the respective forming components in accordance with information processing. The control part 4 includes the image acquisition part 51, a decode part 52, a profile information identification part 53, a determination part 54, a border element identification part 55, a border identification part 56, a region identification part 57, and a text reading part 6. Among the configurations included in the control part 4, the image acquisition part 51, the decode part 52, the profile information identification part 53, the determination part 54, the border element identification part 55, the border identification part 56, and the region identification part 57 are the members forming the symbol border identification device 5.

(Image Acquisition Part 51)

The image acquisition part 51 acquires the image data in which the symbol is photographed and which is output from the camera 2, and outputs the image data to the decode part 52.

(Decode Part 52)

The decode part 52 decodes the symbol photographed in the image data. The decode method of the symbol is not particularly limited as long as conventional technologies are properly used. The decode part 52 outputs a signal indicating the information which the decoded symbol has to a superordinate system 10 via the output part 3.

The superordinate system 10 controls the operation of the symbol reading device 1, and is a personal computer, a programmable controller, etc.

In addition, the decode part 52 identifies the reference positions of multiple elements forming the symbol by decoding the symbol included in the image.

The reference positions, for example, may be the edge points of the respective elements on the scan line used for the decoding process for the symbol, and may be calculated as the centers of the modules forming the respective elements from the edge points. For example, the respective centers of multiple modules included in one element may be calculated as the reference positions. The decode part 52 outputs a signal indicating the reference positions to the profile information identification part 53.

In addition, the decode part 52 may identify reference profile information 58 relating to multiple elements obtained from a decoding result. The decode part 52 stores the reference profile information 581 in the storage part 58.

According to the above configuration, the information obtained through the decoding process can be used in identifying the border of the symbol.

The reference profile information 581 includes, for example, at least one of the binary data of the pixel values of the respective elements or the binary data of the pixel values of the modules forming the respective elements on the scan line used in the symbol decoding process and the normalized values of the widths of the respective elements (the ratio of the width of each element with respect to the predetermined with).

In addition, the decode part 52 stores the image data 583 in which the symbol is photographed in the storage part 58.

According to the configuration, the symbol border identification device identifying the symbol border by using, as the reference profile information, one of the binary data obtained by the decoding process, the width of the element, and the normalized value of the width of the element can be realized.

In addition, the decode part 52 may obtain the reference profile information 581 by carrying out a filter process on the pixels within the range fitting with the module width of the module forming the element.

According to the configuration, the symbol border identification device identifying the symbol border by using the reference profile information 581 obtained from the pixels having undergone the filter process can be realized.

(Profile Information Identification Part 53)

The profile information identification part 53 sets multiple regions based on the reference positions indicated in the signal input from the decode part 52.

Specifically, the profile information identification part 53 sets at least one of the shapes and the positions of the regions based on the reference direction determined by the array of the reference positions of the multiple elements identified by the decode part 52. The reference direction may be the direction of the scan line used in the decoding process for the symbol. In addition, the shape of the region may be one pixel, a line segment, or a rectangular shape. In addition, the specific example regarding the position will be described in detail in “Examples of Identifying Border Point Candidate” in the following.

According to the above configuration, the shape and the position of the region for which the determination on whether the region is in the symbol is performed can be set based on the scan line direction in the symbol decoding.

The profile information identification part 53 may set the region so that one region does not span across multiple elements.

According to the configuration, the symbol border identification device 5 setting a region that does not span across multiple elements, such as a region with an individual element as the target, and identifying the symbol border by using the region can be realized.

In addition, the profile information identification part 53 may set the region so that one region spans across multiple elements.

According to the configuration, the symbol border identification device 5 setting the region that spans across multiple elements, such as a region with multiple elements as the target, and identifying the symbol border by using the region can be realized. For example, it may be that a region with multiple elements as the target is set, and the symbol border of an individual element is identified by using the region.

In addition, the profile information identification part 53 obtains profile information with respect to the multiple regions. For example, the profile information identification part 53 may generate the profile information by using the image data 583 stored in the storage part 58.

The profile information includes, for example, at least one of a pixel value, a pixel value variation, binary data, and a width of an element.

According to the configuration, the symbol border identification device 5 identifying the symbol border by using at least one of a pixel value, a pixel value variation, binary data, and a width of the element can be realized.

In addition, the profile information may include a normalized value of the width of an element (the ratio of the width of an element with respect to the predetermined width).

The profile information identification part 53 outputs a signal indicating the position information of the region that is set and a signal indicating the profile information of the region to the determination part 54.

According to the configuration, the symbol border identification device identifying the symbol border by using the normalized value of the width of the element can be realized. The normalized value of the width of the element, for example, may be a ratio of the width of the element with respect to the width of the entire symbol or the width of the configuration of a portion of the symbol.

(Determination Part 54)

The determination part 54 determines whether the region identified by the profile information identification part 54 is in the symbol based on the input profile information.

For example, the determination part 54 may determine whether the region is in the symbol by matching the profile information with the reference profile information 581 stored in the storage part 58. For example, the determination part 54 may refer to determination information 582 indicating a threshold, etc., of a determination criteria stored in the storage part 58 and perform the determination.

In addition, the determination part 54 may individually determine whether each region is in the symbol with respect to each region set so as not to span across multiple elements.

The determination part 54 outputs a signal indicating the determination result with respect to each region and a signal indicating the position information of the region to the border element identification part 55.

In addition, when a region is determined as not in the symbol, the determination part 54 may instruct the profile information identification part 53 to end the region setting and end the generation of the profile information with respect to the region.

(Border Element Identification Part 55)

The border element identification part 55 identifies at least one border element candidate in the symbol by using the position information of the region determined as in the symbol. The profile information identification part 53 may set the region and obtain the profile information sequentially from the reference position inside the element toward the outside, and the determination part 54 determines whether the region is in the symbol and perform scanning in the element.

In such configuration, in the case where a region is determined as in the symbol in the previous determination, a region is determined as not in the symbol, the position of the region determined as not in the symbol may be set as a border element candidate. Alternatively, in the case where a region is determined as in the symbol in the previous determination and a region is determined as not in the symbol in the current determination, the position of the region where the region is determined as in the symbol in the previous determination may be set as the border element candidate.

That is, in the configuration, the border element identification part 55 may set the position of the region that is set next and determined as not in the symbol as the border element candidate by referring to the position information of the region used in the previous determination and determined as in the symbol. In addition, the position of the region that is set previously and determined as in the symbol may be set as the border element candidate by referring to the position information of the region used in the next determination and determined as outside the symbol. The border element identification part 55 outputs a signal indicating the position of the border element candidate to the border identification part 56.

(Border Identification Part 56)

The border identification part 56 identifies at least one border of the symbol based on the border element candidate. The border identification part 56 outputs a signal indicating the identified border to the region identification part 57.

(Region Identification Part 57)

The image data may include a text string (optical reading medium), etc., separate from the symbol. The region identification part 57 identifies a region for recognizing a text string, etc., by referring to the border of the symbol that is identified. The border identification part 57 outputs a signal indicating the region in which recognition of the identified text string is performed to the text reading part 6.

According to the configuration, the influence of the disturbing noise with respect to the identification of the symbol border can be suppressed, and the region for recognizing the optical reading medium can be identified.

(Text Reading Part 6)

The text reading part 6 performs a text string recognition process in the region in which the recognition of the text string, etc., identified by the region identification part 57 is performed and reads the text. The text reading part 6 outputs a signal indicating the test string that is read to the superordinate system 10 via the output part 3.

(Output Part 3)

The output part 3 outputs a signal to an external apparatus. Specifically in the embodiment, a signal indicating the text string read by the text reading part 6 and a signal indicating information which the symbol decoded by the decode part 52 has are output to the superordinate system 10.

(Storage Part 58)

The storage part 58 is an auxiliary storage device such as a flash memory, a solid state drive, etc., and stores the reference profile information 581, the determination information 582, and the image data 583, etc.

### 3. Operation Example

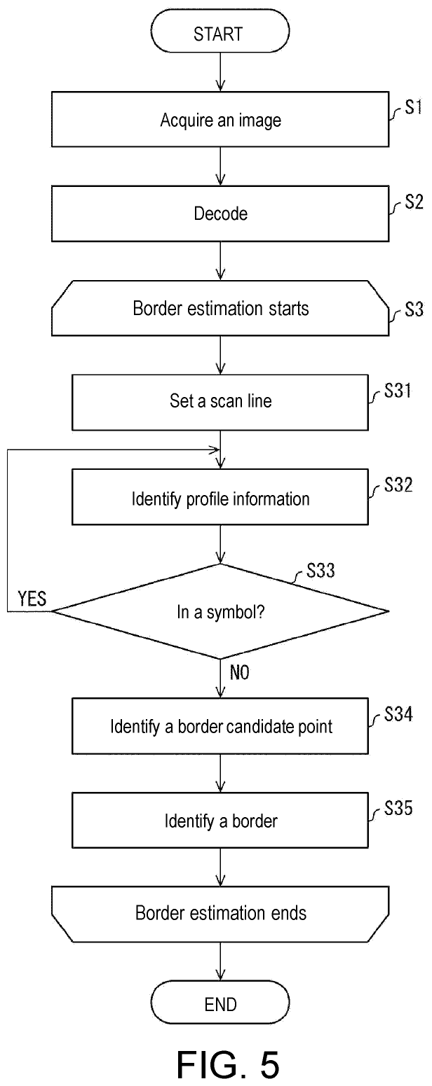

FIG. 5 is a flowchart illustrating an example of a flow of processes executed by the symbol border identification device 5. As shown in FIG. 5, for example, with the instruction from the superordinate system 11 as a trigger, the camera 2 photographs the symbol as the target, and the image acquisition part 51 acquires the image data (S1). Then, the decode part 52 decodes the symbol photographed in the image data (S2: decode step). In Step S2, the decode part 52 may identify the reference positions of multiple elements forming the symbol by decoding the symbol. Then, the process proceeds to a border estimation process (S3).

In the border estimation process (S3), the profile information identification part 53 sets a scanning line (S31).

### Example of Setting Scanning Line (Module Arrangement Direction)

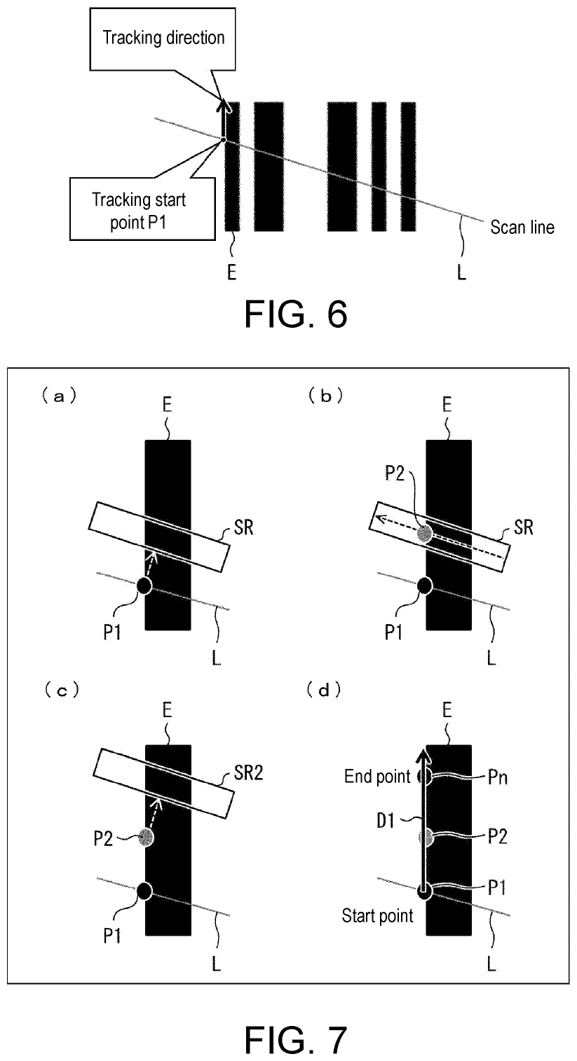

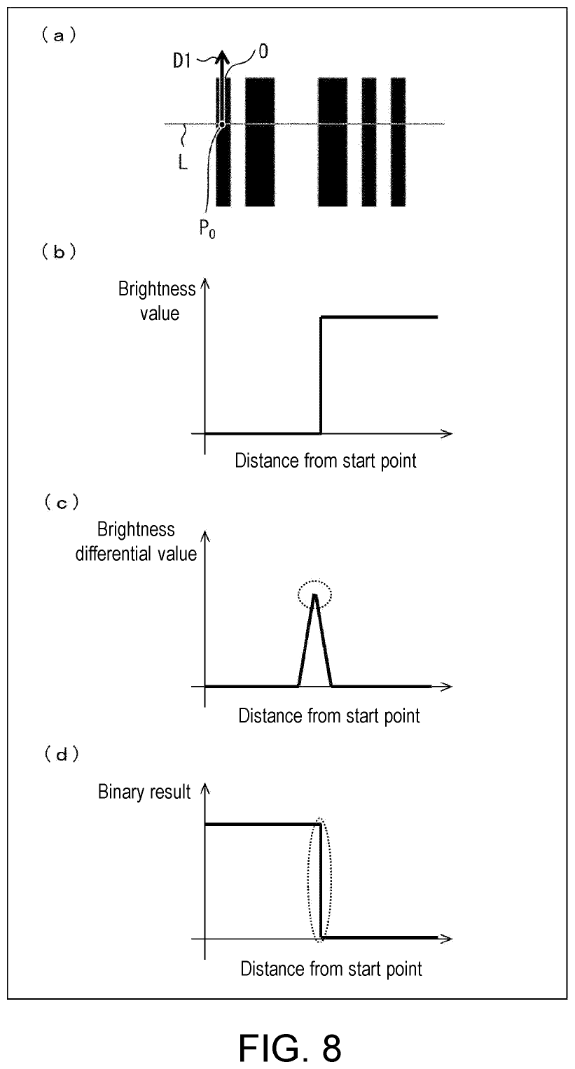

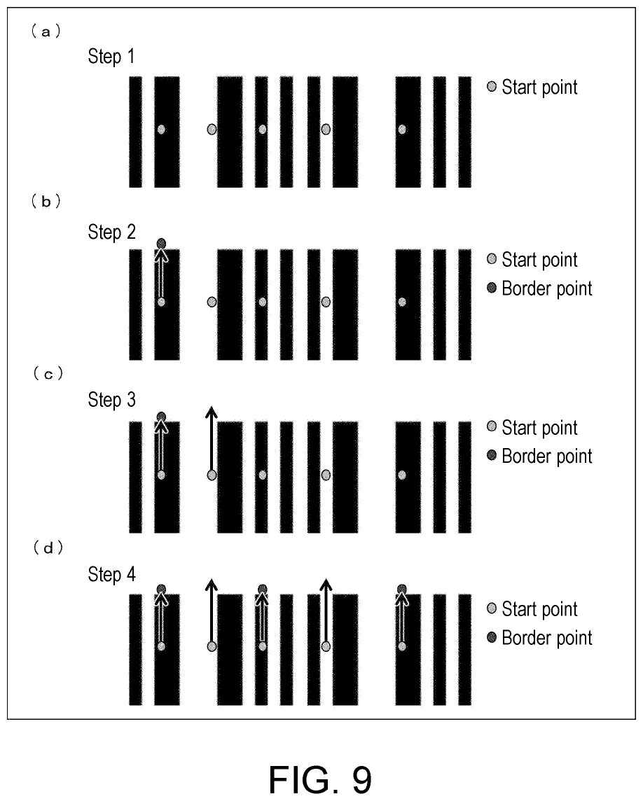

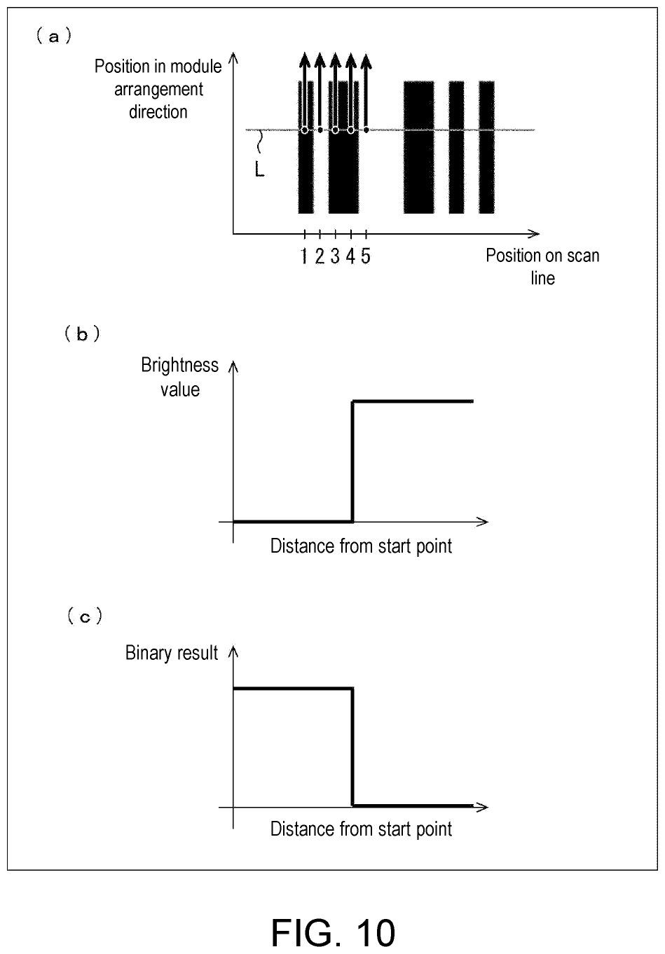

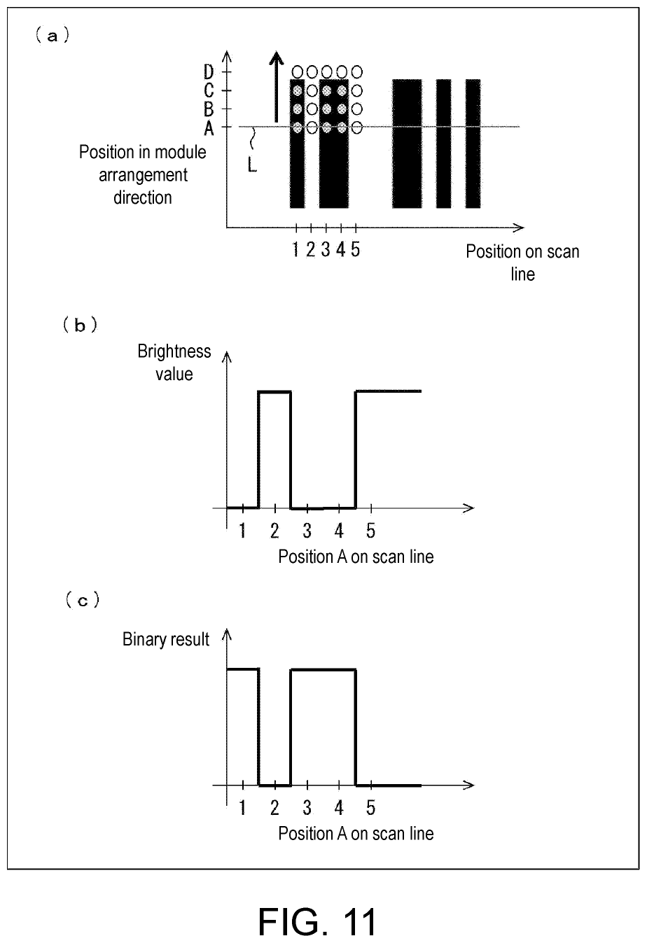

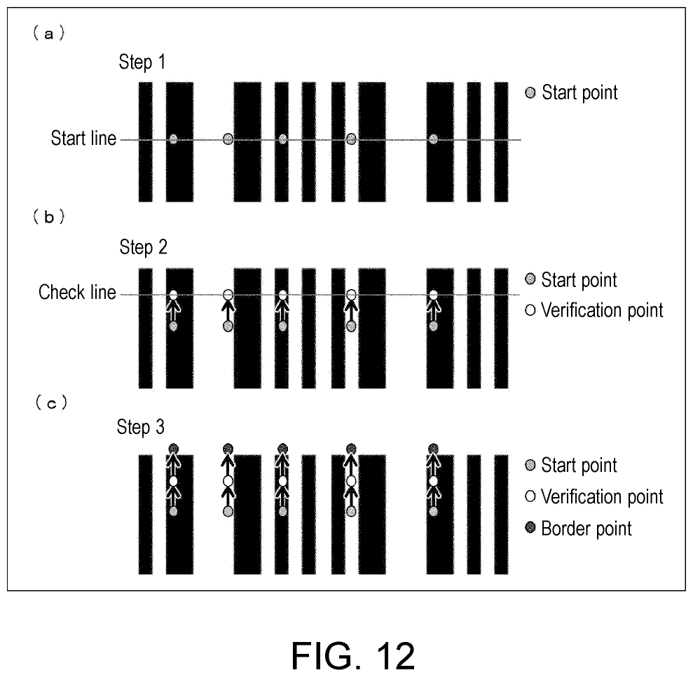

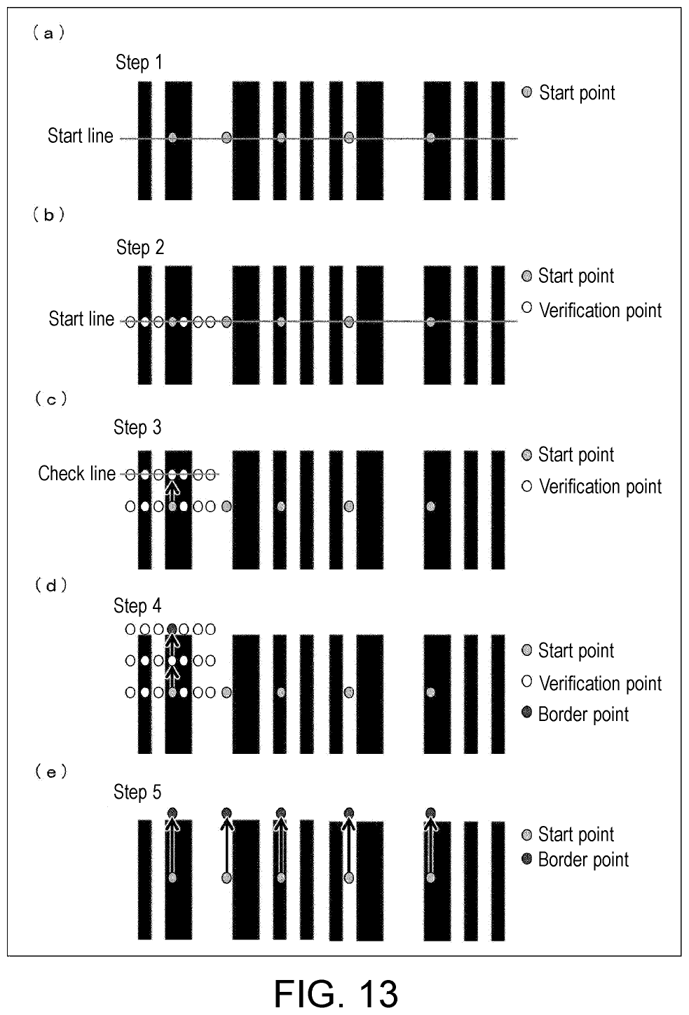

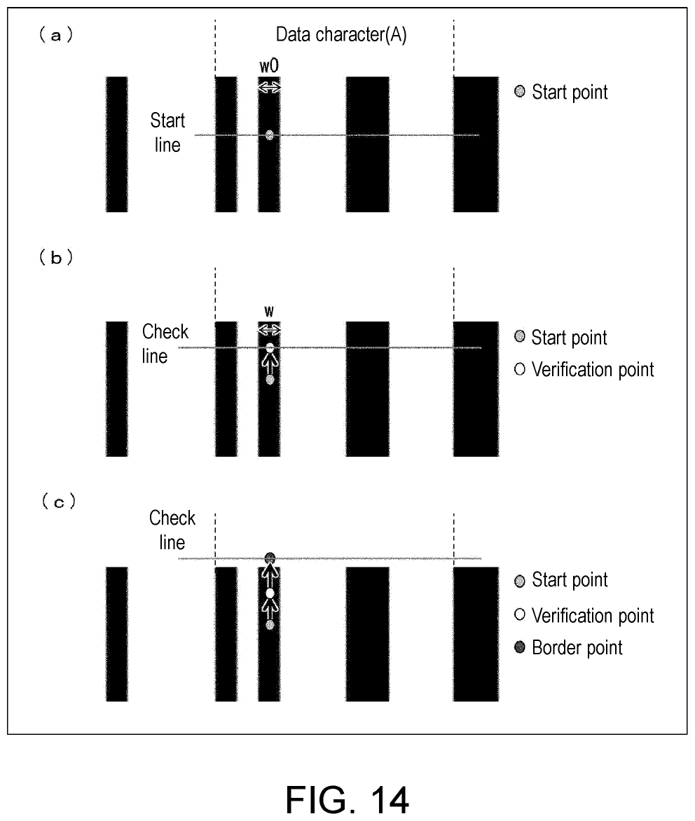

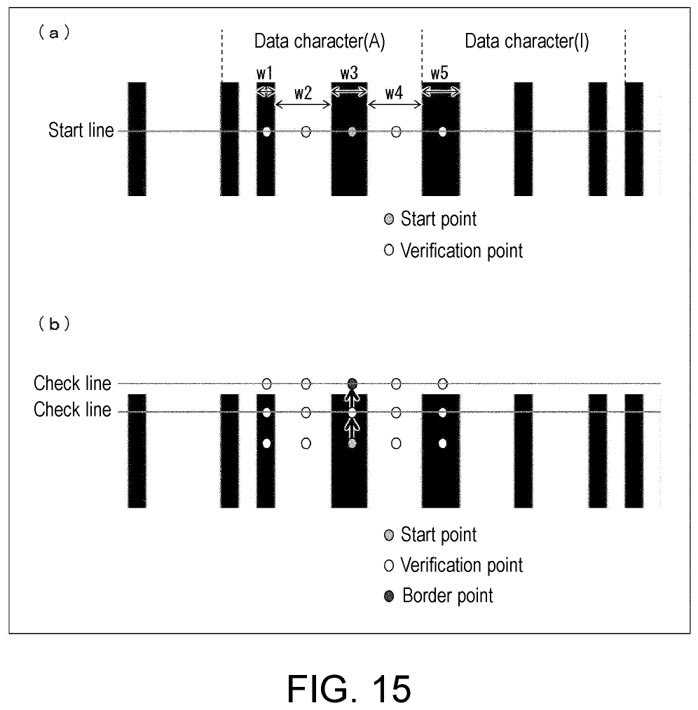

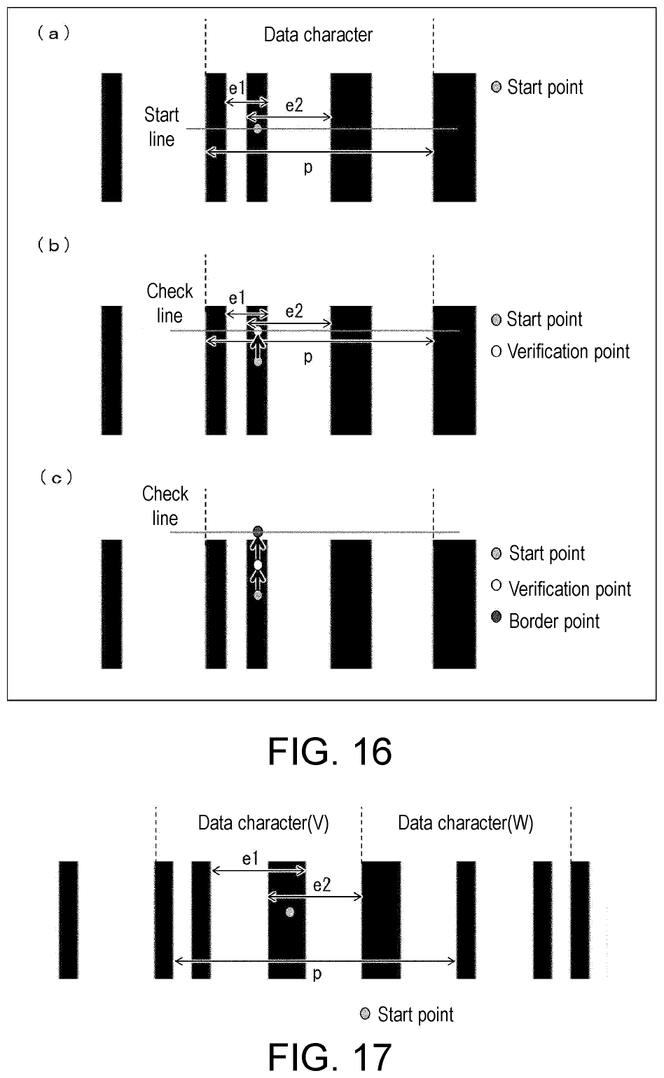

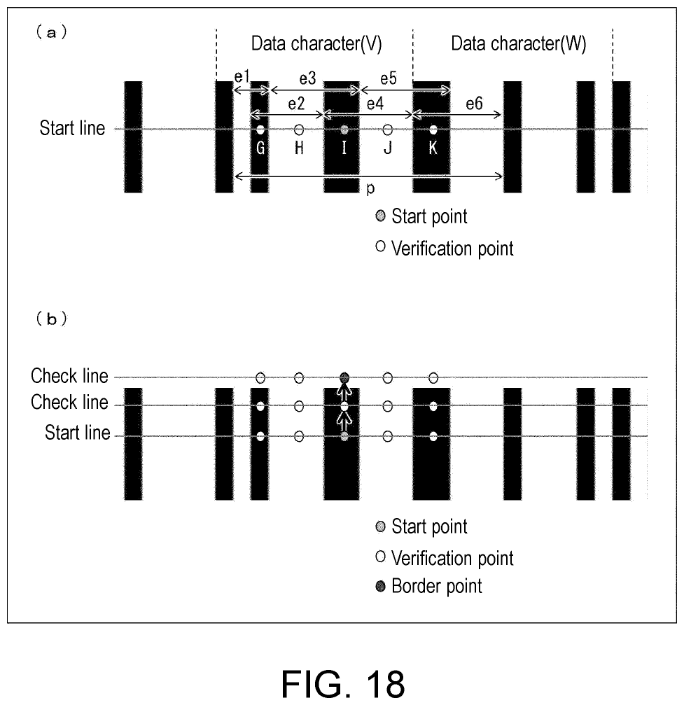

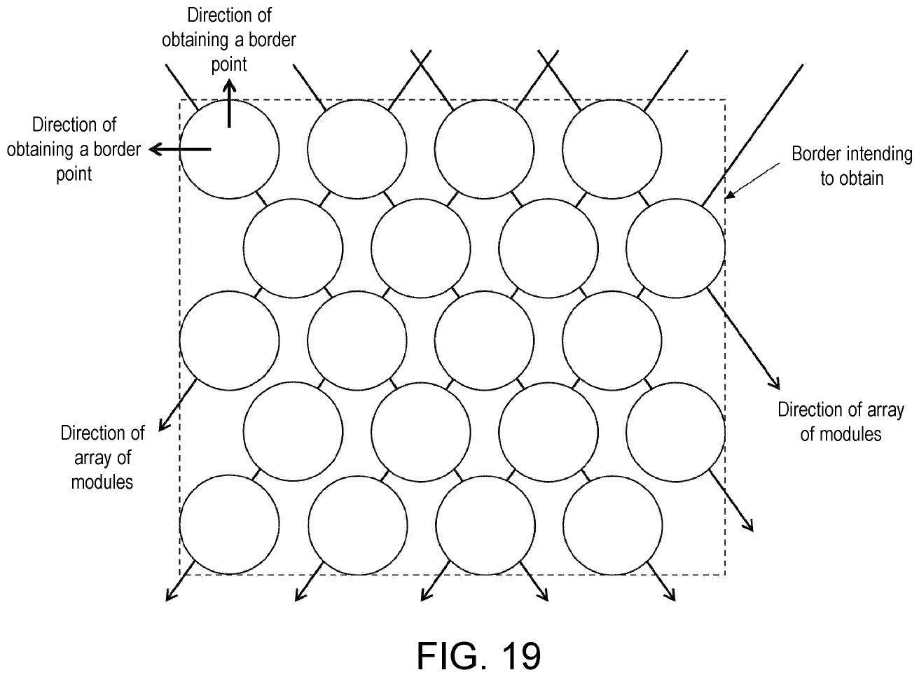

FIG. 6 is a schematic diagram illustrating a method with which the profile information identification part sets the direction of the scanning line according to the embodiment. In the specification, the direction of the scanning line is referred to as a module (element) arrangement direction in the specification. As shown in FIG. 6, the profile information identification part 53 detects a point P1 at which the scan line used by the decode part 52 in symbol decoding intersects with the edge of an arbitrary element E (e.g., a bar). The profile information identification part 53 sequentially tracks the points on the edge of the element E by using the point P1 as a tracking start point. The profile information identification part 53 sets the tracking direction of the points on the edge of the target element as the module arrangement direction.

(a) to (d) of FIG. 7 are diagrams illustrating an example of the method with which the profile information identification part 53 sets the module arrangement direction according to the embodiment. An example of the specific method with which the profile information identification part 53 sets the module arrangement direction is described.

(I) As shown in (a) of FIG. 7, the profile information identification part 53 sets a small region SR parallel to a scan line L at a position in a slight distance away from the tracking start point P1 in a vertical direction with respect to the scan line L. The slight distance may be a fixed value such as one pixel, and may be a variable value in accordance with module size such as 0.5 module.

(II) Then, as shown in (b) of FIG. 7, the profile information identification part 53 detects an edge point P2 of the element E from the inside of the symbol toward the outside (the direction indicated by the arrow in (b) of FIG. 7) in the small region SR that is set. For example, in the case where the symbol color is black and the background color is white, the profile information identification part 53 may detect the position where the pixel is switched from black to white as the edge point.

(III) Then, as shown in (c) of FIG. 7, the profile information identification part 53 sets a a small region SR2 parallel to the scan line L at a position in a slight distance away from the edge point P2 in the vertical direction with respect to the scan line L. Like (II), the profile information identification part 53 detects the next edge point of the element E.

(IV) Then, the profile information identification part 53 repeats the same process as in (III) until it cannot detect an edge point. The profile information identification part 53 sets the edge point that is lastly detected as a tracking end point. The profile information identification part 53 sets the direction of the line passing through the tracking start point and the tracking end point as the module arrangement direction.

For example, the profile information identification part 53 sets the scanning line of the module arrangement direction in the element as the target. The profile information identification part 53 may set the scanning line so as to pass through the central positions of the modules forming the respective elements which are calculated from the edge points of the elements on the scan line used in the decoding process of the symbol.

Following S31, the profile information identification part 53 identifies the profile information of the region set based on the reference position (S32: profile information identification step). For example, the profile information identification part 53 sequentially setting the region and identifying the profile information from the inside of the element to the outside of the element. The profile information identification part 53 sets the region along the scan line. Then, based on the profile information, the determination part 54 determines whether the region is in the symbol (S33: determination step). In the case where the determination part 54 determines that the region is not in the symbol (NO in S33), the border element identification part 55 identifies at least one border element candidate by using the position information of the region determined as in the symbol (S34: border element identification step). Then, the border identification part 56 identifies at least one border of the symbol (S35: border identification step) based on the border element candidate. In the case where the determination part 54 determines that the region is in the symbol (YES in S33), the process returns to S32.

For example, the border identification part 56 may obtain the four sides of the border of the symbol by using straight line approximation or curve approximation. In the configuration, the border identification part 56 may set the intersections of straight lines, etc., as the four corners of the border of the symbol. In addition, the border identification part 56 may identify each border (side) so as to include multiple element candidates.

(Examples of Identifying Border Point Candidate) In the following, specific examples of the process from setting a region by the profile information identification part 53 to identifying a border element candidate (border point candidate) by the border element identification part 55 will be described.

The scanning direction and the scanning line used in the following examples may be the direction of the scanning line generated in “Example of Setting Scanning Line (Module Arrangement Direction)” above and the scanning line.

### Example 1 of Identifying Border Point Candidate

(a) of FIG. 8 is a schematic diagram of an example for identifying a border point candidate. In the example, the reference position is set at a central point P0 of the element or the module on the scan line L used in symbol decoding by the decoding part 52. The profile information identification part 53 sets the central point P0 as the start point, and acquires pixel values (brightness values) of pixels (regions) from the image data 583 along D1 which is the module arrangement direction. That is, the profile information identification part 53 acquires pixel values from the inside to the outside of the element as the profile information.

(b) of FIG. 8 is a graph illustrating an example of the brightness values acquired by the profile information identification part 53. The vertical axis of the graph indicates the brightness value, and the horizontal axis indicates the distance from the start point. As shown in (b) of FIG. 8, the brightness values (pixel values) of the pixels within a predetermined distance from the start point which are located in the element are constant. The pixel at the position exceeding the predetermined distance from the start point is located outside the element. Therefore, the brightness values (pixel values) of the pixels located outside the element are switched from the brightness values (pixel values) of the pixels in the predetermined distance within the element.

(c) of FIG. 8 is a graph illustrating an example of the differential values of the brightness values acquired by the profile information identification part 53. The vertical axis of the graph indicates the differential value of the brightness value, and the horizontal axis indicates the distance from the start point. As shown in (c) of FIG. 8, at the position exceeding the predetermined distance from the start point, that is, at the position where the pixel is outside the element, the differential value of the brightness value reaches the extreme value. The determination part 54 may determine whether each pixel is in the symbol by using the extreme value (variation of pixel values). In addition, the border element identification part 55 may identify the pixel whose differential value of the brightness value reaches the extreme value as the border point candidate.

(d) of FIG. 8 is a graph illustrating an example of binary data of the brightness values (pixel values) acquired by the profile information identification part 53. The vertical axis of the graph indicates the binary value of the brightness value, and the horizontal axis indicates the distance from the start point. As shown in (d) of FIG. 8, the binary values of the pixels within the predetermined distance from the start point which are located in the element are constant.

The pixel at the position exceeding the predetermined distance from the start point is located outside the element. Therefore, the binary values of the pixels located outside the element are switched from the binary values of the pixels in the predetermined distance inside the element. The profile information identification part 53 may generate the binary data as the profile information. The determination part 54 may determine whether each pixel is in the symbol by referring to the position where the values of the binary data are switched. In addition, the border element identification part 55 may identify the pixel located right before the switching of the values of the binary data or the pixel located right after the switching of the values of the binary data as the border point (border point candidate).

The pixel values acquired by the profile information identification part 53 may be pixel values smoothed by using a smoothing filter.

Specifically, the profile information identification part 53 performs a filter process using a space filter having a kernel size fitting with the module width of the module forming the element with respect to the image including the region set based on the reference position. Then, the profile information identification part 53 may obtain the profile information by using pixel values extracted from the image to which the filter process is applied.

In other words, the pixel values acquired by the profile information identification part 53 may be pixel values having undergone a process by a filter possessing a kernel size fitting with the module size. Examples of such filter include filters (smoothing, Gaussian, etc.) with an arbitrary weight or a median filter, a maximum/minimum filter, etc. In addition, the profile information identification part 53 may set the kernel size of the filter as the shape of the region. The kernel size may be set as the lateral length with respect to the arrangement direction of the module.

According to the configuration, the symbol border identification device identifying the symbol border by using profile information obtained from the image having undergone the filter process can be realized.

(a) to (d) of FIG. 9 are schematic diagrams illustrating a flow of a process for individually identifying multiple border points in the example. As shown in (a) of FIG. 9, in Step 1 of the example, the profile information identification part 53 sets multiple start points in the direction in which the modules are arrayed. The direction in which the modules are arrayed is, for example, the direction of the scan line used in decoding of the symbol. Then, as shown in (b) of FIG. 9, in Step 2 of the example, the determination part 54 determines whether the identified region is in the symbol from one start point along the scanning direction, and detects a border point from the position information of the region on which the border element identification part 55 performs determination. Then, as shown in (c) of FIG. 9, in Step 3 of the example, the border element identification part 55 detects a border point from a separate start point along the scanning direction. The example shown in (c) of FIG. 9 illustrates a case where the element at which the start point is set is a space and a border point is not detected. For example, in the case where a border point cannot be detected in the scanning within the predetermined distance from the start point, the border element identification part 55 may be configured to end the detection of the border point setting the start point as the reference position.

Then, as shown in (d) of FIG. 9, in Step 4 of the example, the border element identification part 55 detects the border points one after another from the remaining start points that are set along the scanning direction.

### Example 2 of Identifying Border Point Candidate

Then, an example of simultaneously identifying multiple border points is described.

(a) of FIG. 10 and (a) of FIG. 11 schematically illustrate an example for identifying a border point candidate according to the example. In the example, the reference positions are set at the central points of the modules or the elements on the scan line L used in symbol decoding by the decode part 52. As shown in (a) of FIG. 10 and (a) of FIG. 11, the profile information identification part 53 sets the reference positions on a start line as the start points. The profile information identification part 53 acquires the brightness values (pixel values) along the module arrangement direction and generates binary data (profile information) of the brightness values.

(b) of FIG. 10 is a graph illustrating an example of the brightness values acquired by the profile information identification part 53 in the case where the center of the module with a module color is set as the start point. The vertical axis of the graph indicates the brightness value, and the horizontal axis indicates the distance from the start point.

(b) of FIG. 11 is a graph illustrating the brightness value of each start point (1 to 5) in the start points (the positions of A of the module arrangement direction) on the scan line L shown in (a) of FIG. 11.

(c) of FIG. 10 is a graph in which the brightness values shown in the graph of (b) of FIG. 10 are converted into binary data. The vertical axis indicates the binary value of the brightness value, and the horizontal axis indicates the distance from the start point.

(c) of FIG. 11 is a graph in which the brightness values shown in the graph of (b) of FIG. 11 are converted into binary data. The vertical axis indicates the binary values of the brightness values, and the horizontal axis indicates the positions of the start points (1 to 5) on the scan line L.

As shown in (c) of FIG. 10, the binary values of the pixels within the predetermined distance from the start point located in the element are constant. The pixel at the position exceeding the predetermined distance from the start point is located outside the element. Therefore, the binary values of the pixels located outside the element are switched from the binary values of the pixels within the predetermined distance inside the element. That is, in the case where the center of the module with the module color (e.g., black) is set as the start point, the value of the binary data (value of black) at the start point is different from the value of the binary data (value of white) indicated by a pixel located outside the element.

The determination part 54 performs matching between the pattern of the binary data (profile information) of the pixel values of the multiple pixels (regions) set based on the multiple start points and the pattern of the binary data (reference profile information) of the pixel values at the multiple start points. In the case where the consistency rate between the two patterns of the binary data is lower than a predetermined threshold, the determination part 54 determines that the multiple pixels (regions) that are set are not in the symbol. The predetermined threshold may be stored as the determination information 582 in the storage part 58.

For example, as shown in (a) of FIG. 11, the binary data of the pixels at the positions 1 to 5 in the scan line direction of the scan line L (position A along the module arrangement direction) show a pattern of black, white, black, black, and white. Meanwhile, the binary data of the pixels at the positions 1 to 5 in the scan line direction at the position D along the module arrangement direction, which are located outside the symbol, show a pattern of white, white, white, white, and white. That is, in the case where the pattern of the binary data of the pixel values of the multiple pixels (regions) set based on the multiple start points are different from the pattern of the binary data of the pixel values at the multiple start points, the chance that the multiple pixels are located outside the symbol is high. Therefore, for example, the border element identification part 55 identifies the pixels indicating the pattern whose consistency rate is low as the border point.

(a) to (c) of FIG. 12 are schematic diagrams illustrating a flow of a process for simultaneously identifying multiple border points in the example. As shown in (a) of FIG. 12, in Step 1 of the example, the profile information identification part 53 sets multiple start points on the start line in the direction in which the modules are arrayed. The start line, for example, is the scan line used for decoding the symbol.

Then, as shown in (b) of FIG. 12, in Step 2 of the example, the determination part 54 determines whether verification points arrayed on a check line set in parallel with the start line and at the positions along the scanning direction from the respective start points are in the symbol. The determination part 54 performs matching between the pattern of the binary data of the pixel values of the verification points set based on the multiple start points and the pattern of the binary data of the pixel values at the multiple start points. The profile information identification part 53 sequentially sets the check line (region) and the verification points (regions) from the inside to the outside of the symbol from the start line.

As shown in (c) of FIG. 12, in Step 3 of the example, in the case where the consistency rate between the two patterns of the binary data is lower than a predetermined threshold, the determination part 54 determines that the multiple verification points that are set are not in the symbol. The border element identification part 55 identifies the pixels indicating a pattern whose consistency rate is lower than a predetermined value as the border points. Or, the border element identification part 55 may identify, as the border points, the pixels located at multiple verification points indicating a pattern whose consistency rate is higher than the predetermined value and set right before multiple verification points indicating a pattern whose consistency rate is lower than the predetermined value.

According to the configuration, the border points can be identified by using the binary data of the pixels scanned from the multiple start points. Therefore, even in the case where the pixel values of some pixels are not values reflecting values inside and outside the symbol due to dirt at a local position, etc., correct border point candidates can still be detected.

### Example 3 of Identifying Border Point Candidate

In the following, an example in which one border point candidate is identified from multiple verification points arrayed in the scan line direction is described.

(a) to (e) of FIG. 13 are schematic diagrams illustrating a flow of a process for identifying one border point candidate from multiple verification points arrayed in the scan line direction according to the example. In the example, the reference positions are set at the central points of the modules or the elements on the scan line L used in symbol decoding by the decode part 52. As shown in (a) of FIG. 13, in Step 1 of the example, the profile information identification part 53 sets multiple reference positions on the start line as the start points. The start line, for example, is the scan line used for decoding the symbol.

Then, as shown in (b) of FIG. 13, in Step 2 of the example, the profile information identification part 53 sets, with respect to one start point, verification start points (verification points) in one or more modules within a predetermined range from the module in which the start point is set. The verification start points are set to be arrayed on the start line.

Then, as shown in (c) of FIG. 13, in Step 3 of the example, the determination part 54 determines whether the verification points which are arrayed on the check line set in parallel with the start line and at the positions along the scanning direction from the start point and the verification start point are in the symbol. For example, the determination part 54 performs matching between the pattern of the binary data (profile information) of the pixel values of the verification points and the pattern of the binary data (reference profile information) of the pixel values at the start point and the one or more verification start points. Regarding the matching of the patterns, the method described in “Example 2 of Identifying Border Point Candidate” above can be applied.

Then, as shown in (d) of FIG. 13, in Step 4 of the example, in the case where the consistency rate between the two patterns of the binary data is lower than the predetermined threshold, the border element identification part 55 identifies one verification point at the position in the scanning direction from the start point as the border point.

Then, as shown in (e) of FIG. 13, for other start points, border points are identified in a similar manner by using the method.

There is also a case where the scan line used by the decode part 52 to decode the symbol is not perpendicular to the module arrangement direction. In such case, the border line of the symbol is not parallel to the scan line. Therefore, at the verification points set based on the verification line set to cross the border line of the symbol, there is a chance that those present in the symbol and those present outside the symbol are mixed.

According to the configuration, the verification start points are set in one or more modules within a predetermined range from the modules in which the start points are set. Therefore, the chance that, in the verification points, those present in the symbol and those present outside the symbol are mixed is reduced. That is, the border point can be identified accurately.

### Example 4 of Identifying Border Point Candidate

Then, an example in which a border point candidate is identified by using the width of an element in the direction of the scan line used in decoding of the symbol is described.

(a) to (c) of FIG. 14 are schematic diagrams illustrating a flow of a process for identifying a border point candidate by using the width of an element in the scan line direction in the example. In the example, the reference position is set as the central point of the module or the element on the scan line L used in symbol decoding by the decode part 52. As shown in (a) of FIG. 14, firstly, the profile information identification part 53 sets the reference position on the start line with respect to the target element as the start point. The start line, for example, is the scan line used for decoding the symbol.

Then, as shown in (b) of FIG. 14, the determination part 54 determines whether the verification point on the check line set in parallel with the start line and at the position along the scanning direction from the start point is in the symbol. For example, the determination part 54 performs matching between a width w (profile information) of the element at the verification point and a width w0 (reference profile information) of the element at the start point.

For example, the width w0 of the element at the start point may be a distance between two adjacent element edge points on the scan line used in decoding of the symbol. In addition, the width w0 of the element at the start point may be a run-length in which the same value remains in the binary data on the scan line. In addition, the width w of the element at the verification point may be a run-length which includes the data of the position of the verification point and in which the same value remains in the binary data on the check line.

In the case where the consistency rate between the width w of the element at the verification point and the width w0 of the element at the start point is lower than a predetermined threshold, the determination part 54 determines that the verification point that is set is not in the symbol. The predetermined threshold may be stored as the determination information 582 in the storage part 58. For example, if the width w at the verification point is within a range from 80% to 120% of the width w0 at the start point, the determination part 54 determines that the verification point is in the symbol. The profile information identification part 53 sequentially sets the check lines and the verification points from the inside to the outside of the symbol from the start line.

Then, as shown in (c) of FIG. 14, in the case where the width of the element at the verification point cannot be obtained, the determination part 54 determines that the verification point is outside the symbol. In addition, in the case where the consistency rate between the width w of the element at the verification point and the width w0 of the element at the start point is lower than the predetermined threshold, the determination part 54 determines that the verification point is outside the symbol. The border element identification part 55 identifies the verification point determined as outside the symbol as the border point.

### Example 5 of Identifying Border Point Candidate

Then, an example in which a border point candidate is identified by using the widths of multiple elements in the direction of the scan line used in decoding of the symbol is described.

(a) and (b) of FIG. 15 are schematic diagrams illustrating a flow of a process for identifying one border point candidate by using the widths of multiple elements in the scan line direction in the example. In the example, the reference position is set as the central point of an element or a module on the scan line used in symbol decoding by the decode part 52. As shown in (a) of FIG. 15, the profile information identification part 53 sets the reference position on the start line as the start point. The start line, for example, is the scan line used for decoding the symbol. Then, for example, the profile information identification part 53 sets, with respect to one start point, verification start points (verification points) in one or more elements within a predetermined range from the element in which the start point is set. The verification start points are set to be arrayed on the start line.

Then, as shown in (b) of FIG. 15, the determination part 54 determines whether the verification points set on the check line set in parallel with the start line and at the positions along the scanning direction from the start point or the verification start points are in the symbol.

For example, the determination part 54 performs matching between the width (profile information) of the element at the verification point and widths w1 to w5 (reference profile information) of the element at the corresponding start point or the corresponding verification start points. The corresponding start point or the corresponding verification start points are the start point or the verification start points located on the scanning lines of the respective verification points. The profile information identification part 53 sequentially sets the check lines and the verification points from the inside to the outside of the symbol from the start line.

The determination part 54, for each check line, calculates the number of verification points where the width of the element at the verification point is not obtained or where the consistency rate between the width of the element at the verification point and the width of the element at the corresponding start point or the corresponding verification start point is low. When the number of the calculated verification points on one check line exceeds a threshold, the determination part 54 determines that the verification points included in the check line and at the positions along the scanning direction from the start point are outside the symbol. The threshold may be included in the determination information 582 stored in the storage part 58. In addition, the widths of the element at the start point, the verification start points, and the verification points are the same as the widths of the elements at the start point and the verification points described in “Example 4 of Identifying Border Point Candidate”. The border element identification part 55 identifies the verification point determined as outside the symbol as the border point.

### Example 6 of Identifying Border Point Candidate

An example in which one border point candidate is identified by using a ratio (normalized value) of the width of a set of elements in the direction of the scan line used in decoding of the symbol is described.

(a) to (c) of FIG. 16 are schematic diagrams illustrating a flow of a process for identifying one border point candidate by using a ratio of the element width in the scan line direction used in decoding of the symbol in the example. In the example, the reference position is set as the central point of an element or a module on the scan line used in symbol decoding by the decode part 52. In addition, for the example, an instance in which an element as the target and an element adjacent to the target element are arranged as a set, and a ratio of the width of the set with respect to a width p of a data character is used to identify the border point candidate is described.

In (a) of FIG. 16, as the target element, the second bar from the left in the data character is shown. The profile information identification part 53 sets the reference position on the start line as the start point. The start line, for example, is the scan line used for decoding the symbol. Since the decoding of the symbol has been completed, the array of bars (B) and spaces (S) forming the data character shown in FIG. 16 and the number of modules forming the respective elements can be obtained as (B,S,B,S,B,S)=(1,1,1,3,2,3).

Then, the width of the set of the target element and the element adjacent on the left of the element is two modules. The number of modules forming the entire data character is 11 modules. Therefore, the ratio between the width p (11 modules) of the data character and a width e1 of the set of the target element and the element adjacent on the left of the element is p:e1=11:2.

Then, the width of the set of the target element and the element adjacent on the right of the element is four modules. The number of modules forming the data character is 11 modules. Therefore, the ratio between the width of the data character and a width e2 of the set of the target element and the element adjacent on the left of the element is p:e2=11:4.

Therefore, the following formulae (reference profile information) on the start line are satisfied.

$$1.5 \text{/} 11 \leq e 1 \text{/} p < 2.5 \text{/} 11$$

$$3.5 \text{/} 11 \leq e 2 \text{/} p < 4.5 \text{/} 11$$

Then, as shown in (b) of FIG. 16, the determination part 54 determines whether the verification point set on the check line set in parallel with the start line and at the position along the scanning direction from the start point is in the symbol.

For example, regarding the ratios e1/p and e2/p of the widths on the check line (profile information), the determination part 54 determines whether the verification point on the check line is in the symbol based on whether the following formulae are satisfied. In the case where the following formulae are satisfied, the verification point on the check line is determined as in the symbol.

$$1.5 \text{/} 11 \leq e 1 \text{/} p < 2.5 \text{/} 11$$

$$3.5 \text{/} 11 \leq e 2 \text{/} p < 4.5 \text{/} 11$$

It should be noted that the width of each element on the check line may be a distance between two adjacent element edge points on the check line. In addition, the width of each element may be a run-length in which the same value remains in the binary data on the check line. In addition, the width of each element may be calculated by making the pixel where the differential value of the pixel value (brightness value) is the extreme value on the check line as the edge of the element.

The profile information identification part 53 sequentially sets the check lines and the verification points from the inside to the outside of the symbol from the start line.

Then, as shown in (c) of FIG. 16, regarding the ratios e1/p and e2/p of the widths on the check line, the determination part 54 determines that the verification point is outside the symbol when at least one of the above formulae is not satisfied. The border element identification part 55 identifies the verification point determined as outside the symbol as the border point.

### Example 7 of Identifying Border Point Candidate

Then, another example in which one border point candidate is identified by using a ratio (normalized value) of the width of a set of elements in the direction of the scan line used in decoding of the symbol is described.

For the example, an instance in which an element as the target and an element adjacent to the target element are arranged as a set, and a ratio of the width of the set with respect to the predetermined width p is used to identify the border point candidate is described. The difference of the present example from “Example 6 of Identifying Border Point Candidate” is that the predetermined with p is not the width of the data character but an arbitrary width.

FIG. 17 is a schematic diagram illustrating identifying one border point candidate by using the ratio of the width of the elements in the direction of the scan line used in decoding of the symbol in the example.

As shown in FIG. 17, the arbitrary width p is set across different data characters. The arbitrary width p shown in FIG. 17 is the width of seven elements, and the number of modules forming the respective elements and the array of bars (B) and spaces (S) can be obtained by (S,B,S,B,S,B,S)=(1,1,3,2,3,2,3).

Then, the width of the set of the target element and the element adjacent on the left of the element is five modules. The number of modules forming the arbitrary width p is 15 modules. Therefore, the ratio between the arbitrary width p (15 modules) and the width e1 of the set of the target element and the element adjacent on the left of the element is p:e1=15:5.

Then, the width of the set of the target element and the element adjacent on the right of the element is five modules. The number of modules forming the arbitrary width p is 15 modules. Therefore, the ratio between the arbitrary width p and the width e2 of the set of the target element and the element adjacent on the left of the element is p:e1=15:5.

Therefore, the following formulae (reference profile information) on the start line are satisfied.

$$4.5 \text{/} 15 \leq e 1 \text{/} p < 5.5 \text{/} 15$$

$$4.5 \text{/} 15 \leq e 2 \text{/} p < 5.5 \text{/} 15$$

For example, regarding the ratios e1/p and e2/p of the widths on the check line (profile information), the determination part 54 determines whether the verification point on the check line is in the symbol based on whether the above formulae are satisfied.

In addition, instead of making the target element and the element adjacent to the target element a set, a ratio between the predetermined width p and a width e of the target element may be used for performing a determination. For example, in the example shown in FIG. 17, the fourth bar from the left is formed by two modules. In the case where the border point candidate is identified by using a ratio e/p of the width e of the fourth bar from the left with respect to the arbitrary width p, the determination part 54 determines whether the verification point on the check line is in the symbol based on whether the following formula is satisfied with regard to the ratio e/p of the width of the bar on the check line.

$$1.5 \text{/} 15 \leq e \text{/} p < 2.5 \text{/} 15$$

### Example 8 of Identifying Border Point Candidate

Then, an example in which one border point candidate is identified by using a ratio of the width of a set of multiple elements.

(a) and (b) of FIG. 18 are schematic diagrams illustrating a flow of a process for identifying one border point candidate by using a ratio of the width of a set of multiple elements with respect to the predetermined width p in the example. In the example, the reference position is set as the central point of an element or a module on the scan line used in symbol decoding by the decode part 52. As shown in (a) of FIG. 18, the profile information identification part 53 sets the reference position on the start line as the start point. The start line, for example, is the scan line used for decoding the symbol. Then, for example, the profile information identification part 53 sets, with respect to one start point, verification start points (verification points) in one or more elements within a predetermined range from the element in which the start point is set. The verification start points are set to be arrayed on the start line.

Then, as shown in (b) of FIG. 18, the determination part 54 determines whether the verification points set on the check line set in parallel with the start line and at the positions along the scanning direction from the start point or the verification start points are in the symbol.

For example, as shown in (b) of FIG. 18, regarding the verification point set at the position along the scanning direction from a verification start point G, the determination part 54 determines whether the verification point is in the symbol by using the following two width ratios in the check line including the verification point. The ratios are e1/p, which is a ratio of the width e1 of the element including the verification start point G and the element adjacent on the left of the element with respect to the predetermined width P, and e2/p, which is a ratio of the width e2 of the element including the verification start point G and the element adjacent on the right of the element with respect to the predetermined width P.

Similarly, regarding the verification point set at the position along the scanning direction from a verification start point H, whether the verification point is in the symbol is determined by using e2/p and e3/p, which are the ratios of the widths (e2, e3) with respect to the predetermined width P.

Similarly, regarding the verification point set at the position along the scanning direction from a start point I, whether the verification point is in the symbol is determined by using e3/p and e4/p, which are the ratios of the widths (e3, e4) with respect to the predetermined width P.

Similarly, regarding the verification point set at the position along the scanning direction from a verification start point J, whether the verification point is in the symbol is determined by using e4/p and e5/p, which are the ratios of the widths (e4, e5) with respect to the predetermined width P.

Similarly, regarding the verification point set at the position along the scanning direction from a verification start point K, whether the verification point is in the symbol is determined by using e5/p and e6/p, which are the ratios of the widths (e5, e6) with respect to the predetermined width P.

In the determination on whether each verification point on the check line is in the symbol, since the remaining points are the same as “Example 8 of Identifying Border Point Candidate” above, the descriptions will not be repeated here.

The profile information identification part 53 sequentially sets the check lines and the verification points from the inside to the outside of the symbol from the start line.

When the number of the verification points determined as outside the symbol on one check line exceeds a threshold, the determining part 54 determines the verification points included in the check line and at the positions along the scanning direction from the start point as outside the symbol. The threshold may be included in the determination information 582 stored in the storage part 58.

### 4. Modified Example

The modified example of the embodiment will be described in the following. For the ease of description, the components having the same functions as those of the components described in the above embodiment are labeled with the same symbols and will not be repeated in the following.

The symbol border identification device 5 according to the modified example identifies the border of a two-dimensional symbol in which multiple elements are arranged in two dimensions.

FIG. 19 is a diagram illustrating an example of a two-dimensional symbol whose border is identified by the symbol border identification device 5 according to the modified example. FIG. 19 illustrates an example of a dot code.

As shown in FIG. 19, the profile information identification part 53 according to the modified example may obtain the profile information with respect to multiple region set based on the reference positions of multiple elements arrayed on the outermost side in the two-dimensional symbol.

According to the configuration, the symbol border identification device 5 capable of identifying the symbol border in the two-dimensional symbol can be realized.

### Example of Realizing by Software

The symbol reading device 1 and the control program (the control part 4) (particularly the image acquisition part 51, the decode part 52, the profile information identification part 53, the determination part 54, the border element identification part 55, the border identification part 56, the region identification part 57, the text reading part 6) may be realized by logic circuits (hardware) formed by integrated circuits (IC chips), etc., and may be realized by software.

In the latter case, the symbol reading device 1 and the symbol border identification device 5 are provided with a computer executing the commands of the program as the software for realizing the respective functions. The computer includes, for example, one or more processors and includes a computer readable recording medium storing the program. In addition, in the computer, the processor reads the program from the recording medium and executes the program, thereby achieving the objective of the invention. As the processor, a central processing unit (CPU), for example, can be used. As the recording medium, a “non-transient, tangible computer-readable medium”, such as a read only memory (ROM), etc., a tape, a disk, a card, a semiconductor memory, a programmable logic circuit, etc., can be used.

In addition, a random access memory (RAM), etc., for expanding the program may be provided. In addition, the program may be supplied to the computer via any transmission medium (communication network, broadcast waves, etc.) able to transmit the program. An aspect of the invention may be realized in the form of data signals embedded in carrier waves, in which the program is embodied by electronic transmission.

The invention is not limited to the above-described embodiments, and various modifications can be made within the scope of the claims. The technical scope of the invention also includes embodiments obtained by appropriately combining the technical means disclosed in the different embodiments.

[Appendix]

An aspect of the invention can be expressed as follows.

A symbol border identification device according to an aspect of the invention includes: a decode part, identifying reference positions of a plurality of elements forming a symbol by decoding the symbol comprised in an image; a profile information identification part, obtaining profile information with respect to a plurality of regions set based on the reference positions; a determination part, determining whether the regions are in the symbol based on the profile information; a border element identification part, identifying at least one border element candidate by using position information of the regions determined as in the symbol; and a border identification part, identifying at least one border of the symbol based on the border element candidate.

In addition, a symbol border identification method according to an aspect of the invention includes: a decode step, identifying reference positions of a plurality of elements forming a symbol by decoding the symbol comprised in an image; a profile information identification step, obtaining profile information with respect to a plurality of regions set based on the reference positions; a determining step, determining whether the regions are in the symbol based on the profile information; a border element identification step, identifying at least one border element candidate by using position information of the regions determined as in the symbol; and a border identification step, identifying at least one border of the symbol based on the border element candidate.

According to the configuration, among the regions based on the reference position of the multiple elements identified by decoding the symbol, by using the position information of the region determined as in the symbol, at least one border of the symbol is identified. That is, since the position information of the region determined as in the symbol is used, the identification of the border of the symbol can be less susceptible to the influence due to disturbing noise.

In addition, according to the configuration, the multiple elements identified by decoding the symbol are used. That is, the border of the symbol can be identified by using information obtained by the decoding process. Therefore, the processing time for identifying the symbol border can be reduced.

In the symbol border identification device according to an embodiment of the invention, the decode part may further identify reference profile information relating to the elements obtained from a decoding result, and the determination part determines whether the regions are in the symbol by matching the profile information of the regions with the reference profile information.

According to the above configuration, the information obtained through the decoding process can be used in identifying the border of the symbol.

In the symbol border identification device according to an embodiment of the invention, the profile information identification part may set at least one of shapes and positions of the regions based on a reference direction determined by an array of the reference positions of the elements identified by the decode part.

For example, the reference direction may be the scan direction in symbol decoding. According to the above configuration, the shape and the position of the region for which the determination on whether the region is in the symbol is performed can be set based on the scan line direction in the symbol decoding.

In the symbol border identification device according to an embodiment of the invention, the profile information identification part may set the regions so that one region of the regions does not span across the elements, and the determination part may individually determine whether each of the regions is in the symbol.

According to the configuration, the symbol border identification device setting a region that does not span across multiple elements, such as a region with an individual element as the target, and identifying the symbol border by using the region can be realized.

In the symbol border identification device according to an embodiment of the invention, the profile information identification part may set the regions so that one region of the regions spans across the elements.

According to the configuration, the symbol border identification device setting the region that spans across multiple elements, such as a region with multiple elements as the target, and identifying the symbol border by using the region can be realized. For example, it may be that a region with multiple elements as the target is set, and the symbol border of an individual element is identified by using the region.

In the symbol border identification device according to an embodiment of the invention, the profile information may include at least one of a pixel value, a pixel value variation, binary data, and a width of the element.

According to the configuration, the symbol border identification device identifying the symbol border by using at least one of a pixel value, a pixel value variation, binary data, and a width of the element can be realized.

In the symbol border identification device according to an embodiment of the invention, the profile information may include a normalized value of a width of the element.

According to the configuration, the symbol border identification device identifying the symbol border by using the normalized value of the width of the element can be realized. The normalized value of the width of the element, for example, may be a ratio of the width of the element with respect to the width of the entire symbol or the width of the configuration of a portion of the symbol.

In the symbol border identification device according to an embodiment of the invention, the reference profile information may include at least one of binary data, a width of the element, and a normalized value of the width of the element.

According to the configuration, the symbol border identification device identifying the symbol border by using, as the reference profile information, one of the binary data obtained by the decoding process, the width of the element, and the normalized value of the width of the element can be realized.

In the symbol border identification device according to an embodiment of the invention, the profile information identification part may perform, with respect to an image comprising the regions, a filter process using a space filter having a kernel size fitting with a module width of a module forming the element, and obtain the profile information by using pixel values extracted from the image to which the filter process is applied.

According to the configuration, the symbol border identification device identifying the symbol border by using profile information obtained from the image having undergone the filter process can be realized.

In the symbol border identification device according to an embodiment of the invention, the symbol may be a two-dimensional symbol in which the elements are arranged in two dimensions, and the profile information identification part may obtain the profile information with respect to the regions set based on the reference positions of the elements arrayed on an outermost side in the symbol.

According to the above configuration, the border of the symbol in the two-dimensional symbol can be identified.

In the symbol border identification device according to an embodiment of the invention, the image may include an optical reading medium separate from the symbol, and the symbol border identification device includes a region identification part identifying a region in which recognition of the optical reading medium is performed with reference to the border of the symbol that is identified.

According to the configuration, the influence of the disturbing noise in identifying the symbol border can be suppressed, and the region for recognizing the optical reading medium can be identified. Here, the optical reading medium may include, for example, a text string including numbers, etc.

An image processing program according to an aspect of the invention may cause a computer to function as the symbol border identification device. The image processing program may cause the computer to function as the decode part, the profile information identification part, the determination part, the border element identification part, and the border identification part.

### REFERENCE SIGNS LIST

5: Symbol border identification device;
52: Decode part;
53: Profile information identification part;
54: determination part;
55: Border element identification part;
56: Border identification part;
57: Region identification part;
S2: Decode Step;
S32: Profile Information Identification Step;
S33: Determination Step;
S34: Border Element Identification Step;
S35: Border Identification Step.

1. A symbol border identification device, comprising:
a decode part, identifying reference positions of a plurality of elements forming a symbol by decoding the symbol comprised in an image;
a profile information identification part, obtaining profile information with respect to a plurality of regions set based on the reference positions;
a determination part, determining whether the regions are in the symbol based on the profile information;
a border element identification part, identifying at least one border element candidate by using position information of the regions determined as in the symbol; and
a border identification part, identifying at least one border of the symbol based on the border element candidate.

2. The symbol border identification device as claimed in claim 1, wherein the decode part further identifies reference profile information relating to the elements obtained from a decoding result, and
the determination part determines whether the regions are in the symbol by matching the profile information of the regions with the reference profile information.

3. The symbol border identification device as claimed in claim 1, wherein the profile information identification part sets at least one of shapes and positions of the regions based on a reference direction determined by an array of the reference positions of the elements identified by the decode part.

4. The symbol border identification device as claimed in claim 1, wherein the profile information identification part sets the regions so that one region of the regions does not span across the elements, and
the determination part individually determines whether each of the regions is in the symbol.

5. The symbol border identification device as claimed in claim 2, wherein the profile information identification part sets the regions so that one region of the regions spans across the elements.

6. The symbol border identification device as claimed in claim 1,
wherein the profile information comprises at least one of a pixel value, a pixel value variation, binary data, and a width of the element.

7. The symbol border identification device as claimed in claim 5, wherein the profile information comprises a normalized value of a width of the element.

8. The symbol border identification device as claimed in claim 2, wherein the reference profile information comprises at least one of binary data, a width of the element, and a normalized value of the width of the element.

9. The symbol border identification device as claimed in claim 6, wherein the profile information identification part performs, with respect to an image comprising the regions, a filter process using a space filter having a kernel size fitting with a module width of a module forming the element, and obtains the profile information by using pixel values extracted from the image to which the filter process is applied.

10. The symbol border identification device as claimed in claim 1, wherein the symbol is a two-dimensional symbol in which the elements are arranged in two dimensions, and
the profile information identification part obtains the profile information with respect to the regions set based on the reference positions of the elements arrayed on an outermost side in the symbol.

11. The symbol border identification device as claimed in claim 1, wherein the image comprises an optical reading medium separate from the symbol, and
the symbol border identification device comprises a region identification part identifying a region in which recognition of the optical reading medium is performed with reference to the border of the symbol that is identified.

12. A symbol border identification method, comprising:
a decode step, identifying reference positions of a plurality of elements forming a symbol by decoding the symbol comprised in an image;
a profile information identification step, obtaining profile information with respect to a plurality of regions set based on the reference positions;
a determining step, determining whether the regions are in the symbol based on the profile information;
a border element identification step, identifying at least one border element candidate by using position information of the regions determined as in the symbol; and
a border identification step, identifying at least one border of the symbol based on the border element candidate.

13. A non-transitory computer readable medium, storing an image processing program causing a computer to function as the symbol border identification device as claimed in claim 1, wherein the image processing program causes the computer to function as the decode part, the profile information identification part, the determination part, the border element identification part, and the border identification part.

14. The symbol border identification device as claimed in claim 2, wherein the profile information identification part sets at least one of shapes and positions of the regions based on a reference direction determined by an array of the reference positions of the elements identified by the decode part.

15. The symbol border identification device as claimed in claim 5, wherein the reference profile information comprises at least one of binary data, a width of the element, and a normalized value of the width of the element.

16. The symbol border identification device as claimed in claim 7, wherein the profile information identification part performs, with respect to an image comprising the regions, a filter process using a space filter having a kernel size fitting with a module width of a module forming the element, and obtains the profile information by using pixel values extracted from the image to which the filter process is applied.
